(19) United States
(12) Patent Application Publication
(10) Pub. No.: US 2003/0155452 A1
(43) Pub. Date: Aug. 21, 2003

(54) Equipment and method to withdraw in metered manner coating powder from a powder bag

(75) Inventor: Roland Herget, Schlat (DE)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ITW GEMA AG

(21) Appl. No.: 10/352,913

(22) Filed: Jan. 29, 2003

(30) Foreign Application Priority Data
Feb. 2, 2002 (DE) 102 04 370.1

(51) Int. Cl. A01C 3/06

(52) U.S. Cl. 239/650

(57) ABSTRACT

Equipment and method for feeding coating powder in metered manner from a powder bag (2). A bag covering assembly (12, 32) is placed on the powder bag (2). Thereupon the powder bag (2) is rotated on a reversing unit (6) into an upside-down position wherein coating powder may be fed from the powder bag (2) by means of a powder feed device (40) mounted on the bag covering assembly (12, 32).

The present invention relates to equipment defined in the preamble of claim 1 to remove in metered manner coating powder from powder bag. The invention also relates to a method defined in the preamble of claim 23 to withdraw in metered manner coating powder from a powder bag.

The expression “powder bag” herein denotes any bag-like and pouch-like receptacle consisting of a lightweight and flexible material whereby end segment constituting a filling and withdrawal aperture may be easily manually folded over, i.e. cuffed. Ordinarily such a powder bag consists of plastic or is a plastic foil and therefore is also generally termed a pouch. To enhance its rigidity and to prevent damage, such a bag ordinarily shall be provided in a cardboard or another material from the supplier to the client. Such a powder bag or powder pouch with or without a receptacle is typically called PACKAGE. Ordinarily the customer is a coating plant using the coating powder to coat objects, the powder being applied pneumatically and sprayed onto the object to be coated. The spraying system is often also called “spray gun”, and there are manually or automatically operated spraying system or spray guns. The automatic spraying system or spray guns are remote-controlled and may be mounted in stationary manner or be displaceable relative to an object to be coated, for instance on a stand or on a robot.

The density of the coating powder is very low and as result when being transvased at the customer's site (spraycoating operation) it shall float out of the package or out of the containers being filled and thereby shall contaminate the environment. To preclude this drawback and to circumvent such transvasing labors, a number of proposed solutions already have been advanced.

1^{st} Proposed Solution

The coating powder is moved from the package through a dipping tube fitted with an injector acting as a pneumatic powder pump. In order to keep the package (plastic pouches up to 25 kg in one carton) as small as possible, it is known to set the package obliquely on a platform. However even in this case there does remain a residual quantity of powder of about 1 to 3 kg in a 25 kg package. Such apparatus is known from EP 0 534 807 B1 (U.S. Pat. No. 5,690,450), This design entails however the drawback of requiring a special powder feed device comprising a suction tube and preferably also a covering for the open powder receptacle.

2^{nd} Proposed Solution

As regards a package in the form of a barrel, the barrel cover is replaced by a special cover crossed by an immersion tube fitted with an injector acting as a pneumatic feed pump. In general such barrels are used for powder quantities in excess of 25 kg, for instance 600 kg. Such a barrel fitted with a special cover is known from the patent document EP 0 103 745 B1 (U.S. Pat. No. 4,505,623). This solution however is expensive and appropriate only for large powder quantities.

3^{rd} Proposed Solution

A large package in the form of a bag, the so-called “big bag”, is used up to 1,000 kg. Said big bag is closed at the top and bottom, while being reinforced at the top end or being fitted with suspension eyes to suspend a support system, and being fitted at its lower end with a tear-open seal with a tear string. A power feed device may be connected to the tear-open seal. Following hookup of a powder feed device (injector or valve, ordinarily a so-called pinch valve), The tear-open seal will be opened by means of the tear line. Once the powder feed device has been removed, the powder will freely drop out of the bigbag. It cannot be sealed again, As a result, the powder feed device may only be exchanged or cleaned when the bigbag has become entirely empty.

There is danger relating to a number of different coating powders, for instance made of plastics, that they shall compact in the presence of vibrations and then no longer shall be transportable by gravity or pneumatic suction from the package into the powder feed device. In order to keep the powder “fluid”, it is known to introduce compressed air as the so-called fluidizing air into the package and in this manner to let the powder particles “float” on the fluidizing air. Fluidizing air however entails the drawback that it tends to de-mix the coating powder, namely fine particles will rise with the fluidizing air in the package while coarse particles will sink and collect at the bottom.

When the powder feed device comprises one or several injectors acting as pneumatic pumps, a reduced pressure is entailed in said injectors on account of a flow of conveying air. If the package is mounted above the injector(s), and the coating powder inside the package is fluidized by fluidizing air, then, even when the conveying airflow is shut off, coating powder will drop into the injector. This quantity of powder is larger than that continuously sucked in by the conveying airflow and accordingly it shall be expelled upon turning ON the conveying airflow as a powder pulse (compact, dense powder flow) from a spraying system onto the object to be coated.

The objective of the present invention is to create a design whereby not only large powder bags or powder pouches holding large quantities of powder, but also small powder bags or powder pouches containing small quantities of powder, for instance less than 25 kg, shall allow feeding powder by means of a power feed device in dust-free, metered, simple and economical manner.

This problem is solved by the invention by the characterizing features of claim 1 and by the characterizing features of claim 23.

The present invention offers the advantage of requiring neither special containers nor special covers, nor any dipping tubes dipping into the powder container or powder bag and further not requiring transvasing the coating powder from the powder bag into another powder container for the purpose of spraycoating objects by said coating powder; that no powder dust from the powder bag may enter the outside ambience; without the coating powder dropping out of the powder bag; that the powder feed device may be removed anytime even from a partly empty powder bag and be cleaned or exchanged against another; that the metered powder feed may be implemented not only using fluidized air but also without it and therefore powder pulses (of compact powder balls) shall be precluded when turning ON the powder feed of the injector (excepting, perhaps, when first applying the injector's conveying air following reversing the powder bag from the upright position into the upside-down position); that the powder bag and the powder are more easily handled.

Further features of the present invention are started in the dependant claims.

The invention is elucidated below in relation to preferred embodiments shown in the appended drawings.

FIG. 1 is a sideview of equipment of the present invention in its upright position, a funnel being configured at a height above the deposition surface at which a package may be placed on the deposition surface underneath the funnel, or at which the funnel may be pivoted across the package

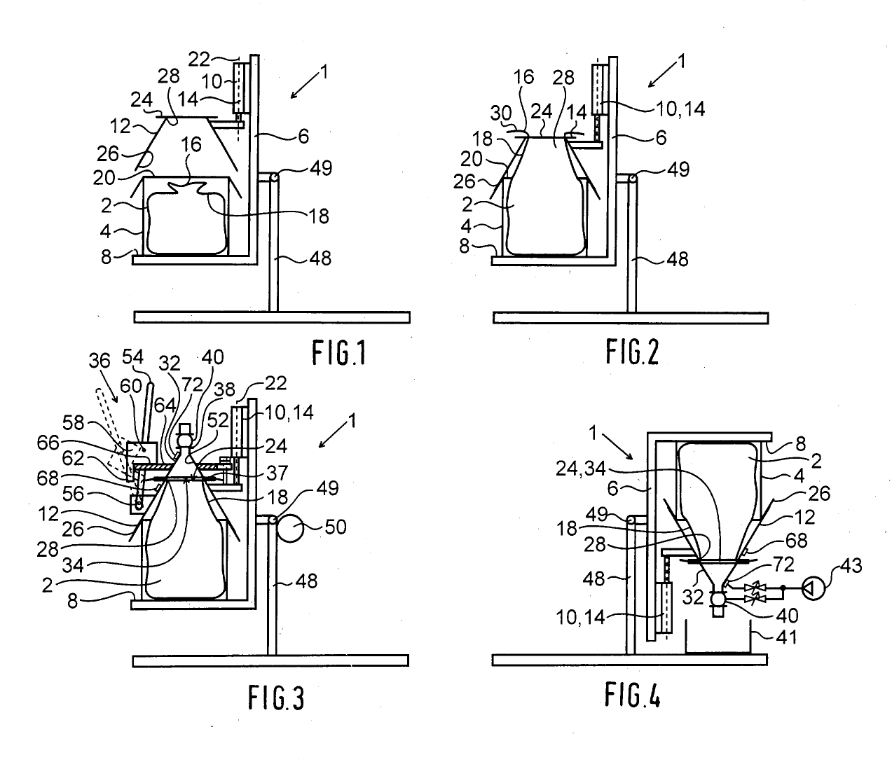

FIG. 2 is the sideview of FIG. 1 wherein the funnel has been lowered onto the package,

FIG. 3 is the sideview of the equipment of the invention if FIGS. 1 and 2 after a head-part was set on and affixed to the funnel, the equipment and the package of FIGS. 1, 2 and 3 being shown in an upright position,

FIG. 4 is a sideview of the equipment of FIGS. 1 through 3, after a reversing unit of the equipment of the invention was revolved jointly with the package about a horizontal (or oblique) axis from the upright position into an upside-down position,

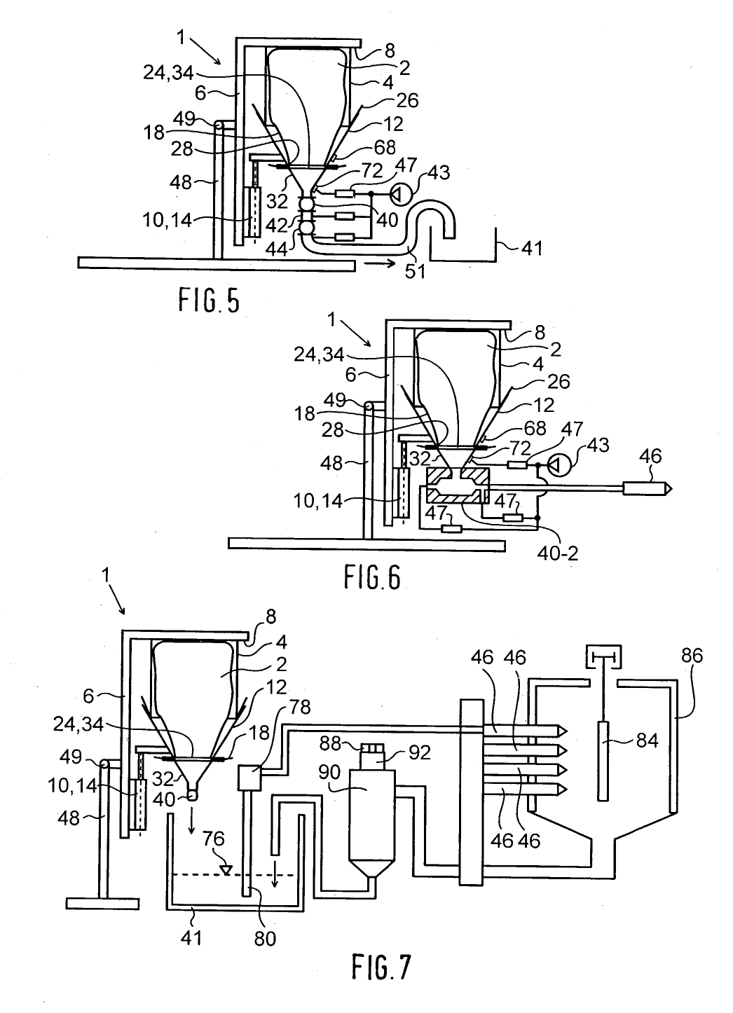

FIG. 5 shows the equipment of FIG. 4 though now fitted with another powder feed device,

FIG. 6 shows the equipment of FIG. 4, though fitted with a still different powder feed device

FIG. 7 shows the equipment of FIG. 4 in its upside-down position, also further components of a powder spraycoating apparatus, said equipment allowing being combined with said apparatus,

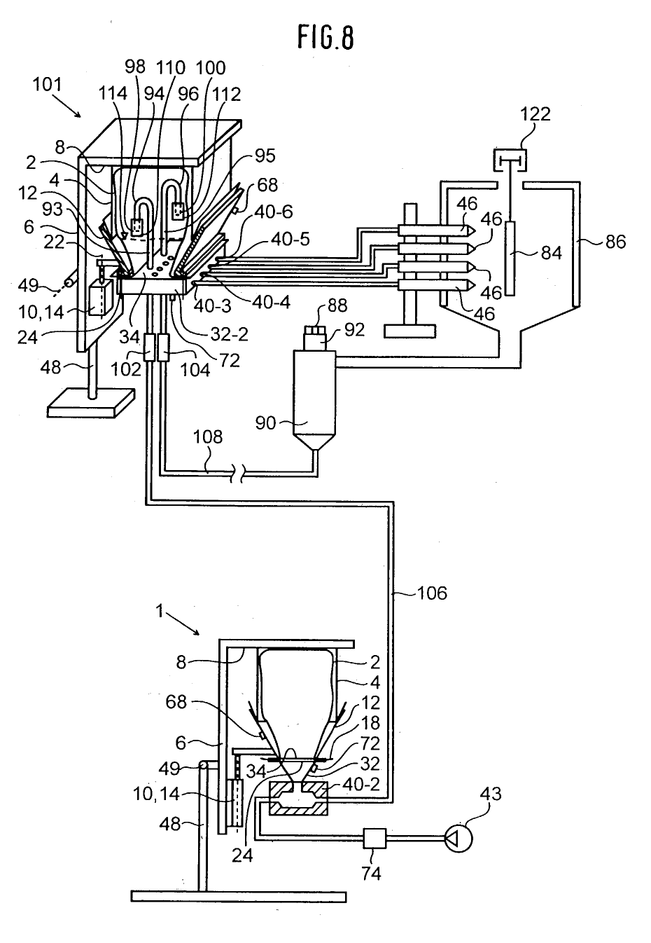

FIG. 8 is a schematic sideview, partly shown in vertical section, of a powder spraycoating apparatus comprising two equipment of the present invention to feed coating powder from a package,

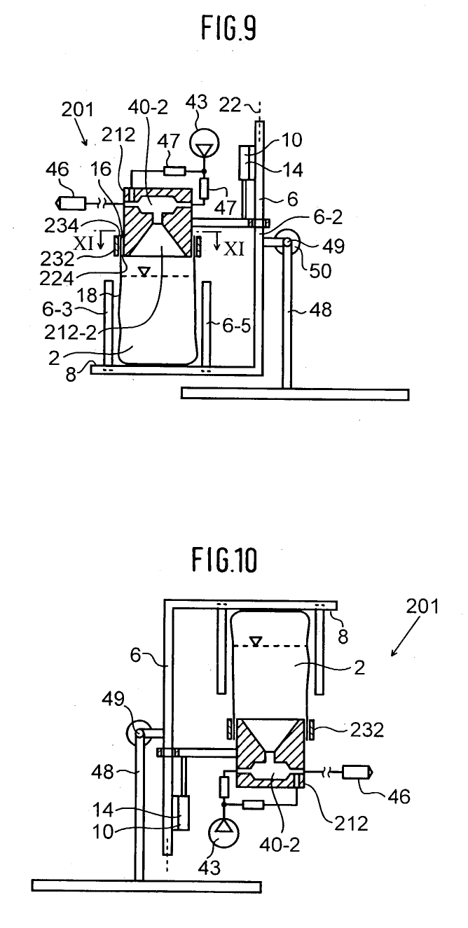

FIG. 9 is vertical section of another equipment of the present invention in its upright position,

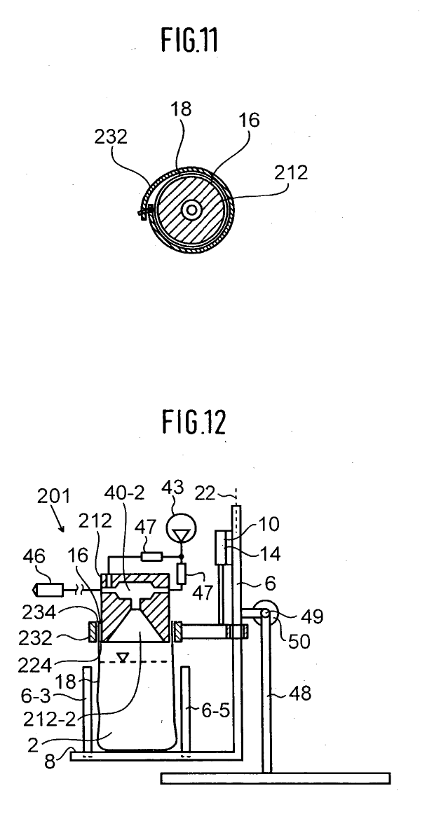

FIG. 10 shows the equipment of FIG. 9 rotated into its upside-down position,

FIG. 11 is a horizontal cross-section in the direction of the arrows XI-XI of FIG. 9, and

FIG. 12 is a vertical section of another equipment of the present invention and similar to that of FIG. 9.

In the description below, the expression “Package” denotes the combination of a container, for instance a cardboard box, and a powder bag received within this container. However the invention also is applicable to powder bags without a container. Within the scope of the present invention, the expression “powder bag” denotes a bag-like or a pouch-like structure of a soft material such as a foil or cloth in a way that, at least in its end zone, the powder bag may be easily bent or laid outward. In general the powder bag is a plastic and therefore it is also often called a powder pouch. As regards the patent claims and the specification, “a container receiving a powder bag or powder pouch” does not mean that the equipment need be designed for both options, but instead that it may be designed for either or for both cases.

Each of the appended drawings shows an illustratively plastic powder bag 2 (which also may be a pouch or the like) inside a container 4 for instance made of cardboard. Jointly the two constitute the so-called package as it is delivered from powder manufacturers to establishments that spray the coating power by means of spraycoating equipment or a spraying system, typically called a spray gun, onto an object to be coated.

The equipment 1 of the invention used to withdraw in metered manner coating powder out of a powder bag 2 contains a reversing unit 6 fitted with a deposition surface 8 receiving the powder bag 2 and a retaining fixture 10 for a funnel 12.

The funnel 12 may be placed on the bag end zone 18 constituting the bag aperture 16 of the powder bag deposited on the deposition surface 8 or alternatively it may be deposited in the reversed position on the aperture rim 20 of the container 4 receiving the powder bag 2 and it is affixed, or affixable, in the deposited position, by the retaining fixture 10 to the reversing unit 6. The expression “funnel” denotes a covering which comprises a funnel-like inside surface exhibiting a maximum cross-section at one funnel end and a minimum cross-section at another funnel end.

In one embodiment of the present invention, the funnel 12 may be placed manually on the powder bag 2 or on the opened container 4 and then be affixed to the reversing unit 6. In the preferred embodiment mode of the present invention, the funnel 12 is affixed to a lifting system 14 of the retaining fixture 10 and may be moved up and down relative to the deposition surface 8, either manually or electrically, preferably pneumatically or hydraulically. To more easily position the package 2, 4 underneath the funnel 12, a preferred embodiment of the present invention provides that the funnel 12 be mounted pivotably about an axis of rotation 22 running orthogonally to the deposition surface 8, illustratively the funnel 12 is pivotable about the lifting element 14 or the lifting element 14 is pivotable about the reversing unit 6. As a result the funnel 12 may be pivoted sideways and then the package 2, 4 may be placed on the deposition surface 8 and thereafter the funnel 12 may be pivoted back above the package 2, 4.

In the downward direction toward the deposition surface 8, the funnel 12 exhibits a funnel-like, flaring cross-section while being fitted at the narrower, upper end with first flange surface 24 assuming the geometry of a frame, for instance an annulus and running radially or obliquely outward from the funnel aperture relative to the center axis while enclosing the funnel aperture like a frame or an annulus and pointing in the same direction as the deposition surface 8, that is upward as regards FIGS. 1, 2 and 3 and downward in FIG. 4.

The cross-sectional aperture of the end 26 situated farther down at least is as large as, or larger than the aperture cross-section of the powder bag 2. The aperture cross-section of the narrower, upper funnel end 28 and its first flange surface 24 is less than the aperture cross-section of the powder bag 2.

In FIG. 1, the funnel 12 is elevated by the lifting element 14 to a height above the deposition surface 8 such that the lower funnel end 26 also shall be higher than the container rim 20 and the upper end of the powder bag 2. As a result the package 2, 4 may be placed underneath the funnel 12. By means of the lifting element 14, the funnel 12 can be lowered from the initial position shown in FIG. 1 into the hookup position shown in FIG. 2 wherein it may be affixed (locked) to the reversing unit 6, whereby said funnel shall henceforth be immobile relative to the reversing unit 6. In this hookup position of FIG. 2, the bag end zone 18 comprising the bag aperture 16 may be pulled manually (or automatically) up through the funnel 12 and then be everted around the first flange surface 24, as a result of which a portion 30 of the bag end zone 18 rests on the first flange surface 24 as shown in FIG. 2.

In another omitted embodiment mode, the lifting element 14 is eliminated and the funnel 12 of FIG. 1 may be manually placed on the package 2, 4 and thereafter be affixed by the retaining fixture 10 to the reversing unit 6 in the hookup position of FIG. 2, whereby the funnel 12 shall henceforth be immobile relative to the reversing unit 6.

As shown in FIG. 3, the invention also includes a head part 32 which is designed to seal off the upper funnel end 28 and which exhibits a second flange surface 34 that may be mounted against the first flange surface 24 in order to clamp the portion 30 of the bag end zone 18 of FIG. 2 between the two flange surfaces 24 and 34. The two flange surfaces 24 and 34 assume an arcuate or polygonal frame-like or annular shape matching the cross-section of the upper funnel end 28. Clamping elements such as screws may be used to affix the head part 32 on the funnel 12 and to simultaneously clamp the everted or turned-out portion 30 of the bag end zone 18 between the two flange surfaces 24 and 34, said screws passing through the flange surfaces 24 and 34 or engaging other portions of the funnel 12 and of the head part 32. Preferably a quick-clamp element 36 shall be used. At one of the two components, namely the funnel 12 or the head part 32, said quick-clamp element may be fitted with pivotably affixed screws and associated wingnuts or with other elements and preferably shall include a tightening lever system of the kind elucidated below.

As regards FIG. 3, the head part 32 comprises a lower end 37 which is fitted with its second flange surface 34 and an upper end 38 where the head part 32 is fitted with a powder feed device 40 preferably situated at the cross-sectional center. As shown in FIGS. 1 through 4, the powder feed device may be a valve allowing gravity flow of the powder from the powder bag when in its upside-down position of FIG. 4 for instance into a powder container 41 or a valve system 42 as shown in FIG. 5 that in addition to the valve 40 also contains a transfer chamber 42 running axially relative to the funnel and containing a second valve 44.

As a result and as shown in FIG. 5, when the first valve 40 is open and the second valve 44 is closed, coating powder may flow by gravity into the valve system 42 which is able to receive a quantity of powder metered in relation to their sizes and which illustratively is in the form of tube stub. Thereafter, by closing the first valve 40 and by opening the second valve 44, the coating powder may drop by gravity into a container 41 below (FIG. 4) or it may be conveyed pneumatically into a powder container 41 spaced away from the equipment 1 (FIG. 5). Preferably the valves 40 and 44 are so-called pinch valves of which the inside wall consists of a flexible hose that may be compressed into a closed position by applying a pneumatic pressure to its outer periphery. To pneumatically move the coating powder, compressed air from a compressed-air source 43 may be transmitted as the conveying air through control valves and/or through a pressure regulator 47 into the valve system 42 and, where called for, also as additional air into the powder path 51 beyond the valve system 42.

In a still further embodiment mode shown in FIG. 6, the powder feed device 40, designated in said Figure by 40-2, may be an injector to pneumatically convey the coating powder from the powder bag 2 to a powder container 41 or to a manual or automatic spraying system 46.

As shown in the drawings, the reversing unit 6 is rotatably supported by a bearing 49 in a post 48 or in a wall or in another machine component, preferably being pivotable about a horizontal axis and, jointly with the package 2, 4 that is clamped or loosely held between the funnel 12 and the deposition surface 8, is pivotable from the upright position shown in FIGS. 1, 2 and 3 into an upside-down position shown in FIGS. 4 through 8. On account of this rotation from upright to upside-down, the powder bag 2 in the funnel 12 is made to be upended and the powder feed device 40, or 40, 42, 44 or 40-2 is situated underneath the bag aperture 16 which is kept open by its end 18 being clamped between the two clamping surfaces 24 and 34. The situation is the same when the powder bag 2 is used in the absence of a container 4. The rotation of the reversing unit 6 relative to the post 48 may be carried out manually or, in the event a motor 50 schematically shown in FIG. 3 were used, in motor-driven manner. The funnel 12 not only keeps the powder bag 2 and its container 4 in the longitudinal bag direction (horizontally), but also transversely to this longitudinal direction.

In the preferred embodiment of the present invention, the head part 32 comprises a conical funnel extension 52 exhibiting a continuous variation from its maximum to its minimum cross-section and constituting a continuation of the funnel 12 when the head part 32 is clamped onto the funnel 12 as shown in FIGS. 3 through 8, the maximum cross-section of the funnel extension 52 preferably matching the minimum cross-section of the funnel 12 (of the same shape and equally large) and being near it, and where the minimum cross-section of the funnel extension 52 is near to or preferably rests against the powder feed device 40 or 40, 42, 44 or 40-2.

Preferably the funnel 12 and/or the funnel extension 52 assumes a continuous, oblique funnel-like shape. The slant of the funnel 12 and of the funnel extension 52 (funnel-like inside surface) preferably shall be 450 or more and in any event shall be steep enough that, on account of gravity, the coating powder shall be able to flow out of the powder bag 2 onto the powder feed device 40 or 40, 42, 44 or 40-2 when the powder bag is in its upside-down position shown in FIGS. 4 through 8.

A preferred embodiment of the quick-clamp device is a clamping lever device as illustrated in FIG. 3. FIG. 3 shows a clamping lever 54 rotatably affixed to the funnel 12 about an axis of rotation 56 transverse to the longitudinal funnel axis and pivotable between an unlocked position and a locked position shown in solid lines. A clamp 58 is pivotably affixed to the clamping lever 54 about a further axis of rotation 60 running parallel to the axis of rotation 56. Preferably the clamping element is fitted with a beak 62 which upon the pivoting motion from the unlocked position into the locked position shall engage from below a clamping element 64 affixed to the head part 32 and thereby shall rotate in such manner the clamp 58 onto this clamping element 64 that a clamping surface 66 of the clamp 58 shall be clamped against the clamping element 64 and hence the head part 32 shall be clamped onto the funnel 12. The clamping lever 54 and the clamp 58 are shown in FIG. 3 in solid lines in the clamping and locked position and moreover in dashed lines in an intermediate position between said clamping and locked position and an unlocked position.

As shown by FIG. 4, a vibrator 68 may be affixed to the funnel 12 to vibrate this funnel in order to keep the coating powder in the fluid state to allow it to flow by gravity out of the powder bag 2 when in its upside-down position even when the funnel's slope alone would be insufficient to implement such a flow.

Preferably the head part 32 (or the funnel 12) is fitted with an air connector 72 to feed compensation air into the powder bag 2 for the purpose of at least partly compensating the reduced pressure entailed by the withdrawal of coating powder. Preferably said air connector 72 is configured at the end of the head part 32 situated in the upside-down position of FIGS. 4 through 8. In this instance said compressed air is able to rise through the powder which in the process it will loosen somewhat. The compressed air may be supplied either continuously as a function of the reduced pressure entailed in the powder bag 2, or it may be applied at timed intervals regardless of said reduced pressure. However this is not the so-called fluidizing air to fluidize the coating powder in the head part 32 or in the powder bag 2, instead the air is applied only at such a low rate that the powder shall not be fluidized and as a result powder de-mixing shall be avoided. If the coating powder were fluidized, there would be danger that it would de-mixed by finer powder particles being carried upward by the air of fluidization while larger and heavier powder particles would migrate downward. Obviously the coating powder also may be fluidized in the invention by fluidizing air introduced through the head part 32 and and further Is through the powder bag 2. However no fluidization is carried out in the preferred mode of implementation, but instead only one or several compressed air connectors 72 shall be used through which compressed air shall be applied at so low a rate that coating-powder fluidization and hence powder de-mixing shall be averted.

In order to exchange one powder bag 2 for another powder bag 2 (or a package 2, 4 for another package 2, 4), the reversing unit together with the package 2, 4 is rotated back from the position shown in FIG. 4 into that of FIG. 3 (or it will be rotated further by 180° in the same direction of rotation)and hence shall be moved from the upside-down position of FIGS. 4-8 into the upright position of FIG. 3. In the position of FIG. 3, the clamping system 36 then is released. Next, manually or using a machine-operated device, the head part 32 is lifted off the funnel 12. Then the funnel 12 is lifted manually or preferably by the lifting element 14 of the retaining fixture 10 away from the powder bag, whereby the first part 30 of the bag end zone 18 that was folded outward around the first flange surface 24 will be wiped clean inward by the upper funnel rim. In this manner coating powder adhering to the inside of the powder bag end zone 18 drops back into the powder bag 2, and as a result coating powder cannot leak into the ambience and contaminate it.

FIG. 7 diagrammatically shows a special application of the equipment 1 of the invention. FIG. 7 shows the equipment 1 of FIG. 4 in its upside-down position wherein the powder bag 2 and the powder feed device 40 are situated above a powder container 41 in order to gravity-feed to it metered quantities of coating powder. Within a predetermined range of tolerances, a predetermine powder level 76 may be maintained in the powder container 41. At least one injector 78 evacuates (suction) coating powder from the powder container 41 through a dipping tube 80 and conveys that powder pneumatically to a spraying system 46. Illustratively four spraying systems 46 are shown, each being supplied with coating powder from another injector 78 in the powder container 41. They spray the coating powder onto an object 84 to be coated inside a coating cabin 86. Excess coating powder is evacuated by a suction blower 88 from the coating cabin 86 and through a cyclone separator 90. Powder separated in the cyclone 90 is fed back from its lower end into the powder container 46 while air and dust are made to pass from the cyclone end through a fine filter 92 separating the dust and expelling the residual air into the ambience.

FIG. 8 shows another application of the present invention. In its lower part, FIG. 8 shows equipment 1 of the invention as shown in FIG. 6 in the upside-down position. The injector 40-2 evacuates (suction) coating powder from the powder bag 2 and moves it pneumatically to a further apparatus 101 of another embodiment mode of the present invention.

When not only one, but instead two or more feed systems are configured in distributed manner across the aperture cross-section of the bag opening 16, whereby the powder bag 2 may be opened so wide that, in the absence of any funnel extension, the angle of said funnel 12 shall be sufficiently steep, for instance being larger than 45°, to allow the coating powder so slide by their own weight—if called for assisted by a vibrator 68—along the oblique walls of the powder bag 2 onto the powder feed device, then the head part 32 need not assume a conical shape or be fitted with a funnel extension 52. In that case the head part may be a parallelipipedic or planar element 32-2 fitted with the second flange surface 34 and affixed/affixable to the feed system or constituting or containing the feed system 40 or 40, 42, 44 or 40-2. Such a design of the present invention is shown in FIG. 8 at the top and on the left in the upside-down position and corresponds to FIG. 4.

As regards the apparatus 101 seen at the top left in FIG. 8, the head part is denoted by 32-2 and comprises at least one, preferably two powder feed tubes 93 and 95 which run from the head part 32-2 toward the funnel 12 and through latter into the powder bag 2. The ends 94, 96 away from the head part 32-2 are bent back pointing to it again This design offers two advantages: first, in the upright position of the reversing unit 8 and of the powder bag 2 (as shown in FIGS. 1, 2 and 3) and when placing the head part 32-2 onto the funnel 12, the ends 94, 96 of the powder feed tubes 35, 35 may be inserted into the coating powder in the powder bag 2 without coating powder being forced into the open tube ends 98, 100. The second advantage is that when in the upside-down position of the reversing unit 6 and powder bag 2 of FIG. 2, no powder can drop from the powder bag 2 into the open tube ends 98, 100. The powder feed tubes 93, 95 are affixed to the head part 32-2. They may pass through the head part 32-2 and may be fitted with connectors 102 or 104 on the outside of said head part. In another design the connectors 102, 104 may be fitted on the head part 32-2 and this head part may be fitted with ducts to the tubes 93 and 95 resp. The outlet of the injector 40-2 of the equipment shown at the bottom of FIG. 8 is connected by means of a connector 102 and through a powder hose 106 to the particular powder feed tube 93

The other powder feed tube 92 is connected by its connector 104 to a powder recovery hose 108 of a powder recovery system, for instance a cyclone 90 fitted with an exhaust air blower 88 and a fine filter 92. The exhaust air blower evacuates excess coating powder from a powder cabin 86, said excess powder recoiling from an object to be coated or being sprayed past it.

The head part 32-2 of the apparatus 101 shown at the top of FIG. 8 contains or constitutes illustratively two or more, for instance four or eight or twelve or another number of injectors 40-3, 40-4, 40-5 and 40-6. The surface of the head part 32-2 facing the powder bag 2 may be flat or like a funnel.

The components -of FIG. 8 corresponding to those of FIGS. 1 through 6 are denoted by the same reference numerals.

The upper apparatus 101 of FIG. 8 furthermore shows that not only cross-sectionally circular packages 2, 4 or powder bags 2, but also those having square or other polygonal cross-sections are applicable. For instance the apparatus 101 shown at the top of FIG. 8 exhibits a cross-sectionally rectangular container 4, and consequently the cross-section of the powder bag 2 also is rectangular. However, even in the absence of a polygonal container 20 4, the powder bag 2 itself still might be polygonal.

The injectors 40-3, 40-4, 40-5 and 40-6 move coating powder from the powder bag 2 through powder hoses to manual or preferably automated squirting or spraying systems 46. Said systems are directed by means of slits in the cabin 86 toward the object to be coated 84 which moves through the cabin 86 while being automatically controlled by a conveyer device 122.

In another, omitted embodiment mode, the head part 32-2 of the apparatus 101 also may be fitted with or constitute a conical funnel extension 52 as already described above in relation to FIGS. 1 through 4 when said extension shall be required or appropriate on account of the size of the powder bag 2, in particular on account of the size of its cross-section and of the quantity of powder in said bag.

As regards a special embodiment mode of the invention, very soft/flexible hose segments 110 or 112 are mounted on the bent-back ends 94 resp. 96 of the powder feed tubes 93 and 95 of the apparatus 101 shown at the top of FIG. 8. The hose segments 94 and 96 comprise a hose element projecting beyond the open tube end 98 resp. 100 and they are so soft/flexible that the projecting hose element may be pinched by externally compressing coating powder and hence be automatically sealed off while nevertheless it may be forced open again by a powder flow moving through the powder feed tube 93 or 95 into the powder bag 2. The soft/flexible hose segments 94 and 96 in this manner may act as check valves preventing coating powder from entering the powder feed tubes 93 and 95. The powder level for instance is shown by the reference 114.

The funnel 12 may be replaced by a flange comprising the first funnel surface 24 but lacking a funnel shape at its inner periphery if, in the upside-down position, the cross-sectional aperture of the funnel extension 52 is large enough for the coating powder to drop by gravity out of the powder bag 2 into the powder path of the head part 32 or 32-2 and its powder feed device.

Besides replacing the funnel 12 with a flange, the funnel extension 52 of the head part 32 or 32-2 may furthermore be eliminated when the cross-sectional aperture of the powder receiving opening(s) all in all within the head part 30 or 32-2 run(s) substantially across the entire cross-sectional opening of the powder bag 2.

As regards FIGS. 1 through 8, on one hand the funnel 12 or a flange replacing it and on the other hand the head part 32 or 32-2 do jointly constitute a bag covering assembly.

FIGS. 9, 10 and 11 show a further embodiment mode of an apparatus 201 of the invention to feed coating powder in metered manner into a powder bag 2 which is fitted with a different bag covering. This bag covering contains a head part 212 which may be inserted into the bag aperture 16 of the powder bag 2, and it further contains a clamping ring 232 externally enclosing the outside of the bag end zone 18 near the bag aperture 16. At its outer periphery, the head part 212 comprises a first flange surface 224 pointing radially outward which is opposite a radially inward-;pointing flange surface 234 of the clamping ring 232. The bag end zone 18 runs between the two clamping surfaces 224 and 234 and may be clamped between them by radially tightening the clamping ring 232 in order to keep the powder bag 2 open and to connect and affix it at its upper end to the reversing unit 6.

The head part 212 comprises at least one or more injectors 40-2 which illustratively may be constituted inside the head part 212 or be affixed to it. Instead of being fitted with an injector, the head part 212 also may be fitted with one or more valves corresponding to the pinch valves 40 or 40 and 44. By means of these pinch valves, and when the powder bag jointly with the reversing unit is in the upside-down position 6 shown in FIG. 10, powder can be fed to a powder receiving device, for instance to a container 41 or one or more spraying systems 46 or to a further apparatus such as apparatus 101 of the invention shown in FIG. 8.

In the embodiment shown in FIGS. 9, 10 and 11, the powder bag 2 may be situated in a first, illustratively cardboard container 4 as shown in FIGS. 1 through 4, or—again as shown in FIGS. 1 through 4—it may be placed without a container 41 on the deposition surface 8 of the reversing unit 6. The powder bag may either rest against a rear wall 6-2 of the reversing unit 6 or additional rests 6-3 and/or 6-5 may be included in the reversing unit 6 to support the powder bag 2 at least in that direction where gravity points it during the rotation about the axis of rotation of the bearing 49.

The surface 212-2 of the head part 212 pointing into the powder bag 2 may be flat, funnel-like or other, depending on the number and the shape of the apertures it subtends for a corresponding number of powder feed devices 40 or 40, 42, 44. As shown in FIG. 9, the funnel exhibits its maximum cross-section at that end facing the inside of the powder bag 2 and its minimum cross-section at its end away from the powder bag 2.

In order to affix the bag covering 212, 213 to the reversing unit 6, the head part 212 and/or the clamping ring 232 may be connected and affixable to the reversing unit 6 either manually or preferably automatically in the manner that was described above in relation to the other Figures. FIG. 9 shows one embodiment mode whereby the head part 212 is affixed in both height- and position-adjustable manner by means of the lifting element 14 of the retaining fixture 10 to the reversing unit 6. FIG. 12 shows an embodiment mode whereby the clamping ring 232 can be adjusted in height and position by the lifting element 14 of the retaining fixture 10 to the reversing unit 6. FIG. 9 shows the apparatus 201 in its upright position. FIG. 10 shows the same apparatus in its upside-down position. FIG. 12 shows the second embodiment mode in its upright position. FIG. 11 is a horizontal section of the head part 212, of the bag end zone 218 with bag aperture 16, and the clamping ring 232.

In all embodiment modes of the invention, a bag covering is mounted to a powder bag 2 in its upright position, said cover allowing powder removal for said bag's upside-down position, and the invention furthermore provides a reversing unit 6 bearing the powder bag and able to rotate same from its upright into the upside-down position.

1. Equipment to feed powder from a powder bag,
characterized in that
it comprises a bag covering (12, 32; 12, 32-2; 212, 232) which is fitted with two frame-like flange surfaces (24, 34; 224, 234) to clamp and thereby to keep open the bag end zone (18) comprising the bag aperture (16) and which constitutes a powder feed device (40; 40, 42, 44; 40-2) or is or may be fitted with latter, in that it further comprises a reversing unit (6) which is rotatable between an upright position and an upside-down position and includes a receiving assembly (8, 10, 12, 14; 8, 10, 12, 14, 6-2, 6-3, 6-5) to support and hold the powder bag (2) whereby the powder bag (2) can be rotated by the reversing unit (6) between an upright position and an upside-down position, and in that the powder feed device is designed to feed in metered manner coating powder evacuated from the powder bag (2) when in its upside-down position.

2. Equipment as claimed in claim 1, characterized in that the bag covering is sub-divided into two mutually displaceable parts (212, 232) each of which is fitted with one of the two flange surfaces (224 resp. 234), and in that the powder feed device is mounted on one of said two parts.

3. Equipment as claimed in at least one of the above claims, characterized in that the receiving assembly of the reversing unit (6) comprises a deposition surface (8) to emplace the powder bag (2) or a container (4) holding the powder bag.

4. Apparatus as claimed in at least one of the above claims, characterized in that the receiving assembly includes a retaining fixture (10, 12, 14; 212, 10, 14, 6-2; 212, 10, 14, 6-3, 6-5) supporting the powder bag (2) in its upside-down position.

5. Equipment as claimed in claim 4, characterized in that the support bearing the powder bag (2) in its upside position consists at least in part of the bag covering (12; 212, 232).

6. Equipment as claimed in at least one of the above claims, characterized in that the receiving assembly comprises two parts, of which at least one part (32; 32-2; 212; 232) is adjustable in height relative to the other part (8) in the longitudinal direction of the powder bag (2), both parts being affixed or affixable to the reversing unit (6).

7. Equipment as claimed in at least one of the above claims, characterized in that it includes components (10, 12,14; 10, 14, 212, 6-2; 10, 14, 212, 6-3, 6-5; 232,10, 14, 62; 232, 10, 14, 6-3, 6-5) bracing the powder bag (2) on the reversing unit (6) at least opposite its direction of tipping.

8. Equipment as claimed in at least one of the above claims, characterized in that it includes a head part (212) insertable into the bag aperture of the powder bag (2) and comprising where called for a powder feed device (40; 40, 42, 44; 40-2) and a clamping frame (232) that may be clamped on said head part, the bag end zone (18) fitted with the bag aperture being clampable between the head part (212) and the clamping frame (232), and at least one of the two components, namely head part and/or clamping frame, being affixed or affixable to the reversing unit (6).

9. Equipment as claimed in at least one of the above claims, characterized in that the reversing unit (6) includes a deposition surface (8) for the powder bag (2) and a retaining fixture (10), in that it further includes a funnel (12) which may be reversibly mounted on the bag end zone (18) constituting the bag aperture (16) of powder bag (2) placed on the deposition surface (8) or on the opening's rim (20) of a container (4) holding the powder bag (2), said funnel in its mounted state being affixed or affixable by means of the retaining fixture (10) to the reversing unit (6) and exhibiting an opening cross-section increasing like a funnel in the downward direction toward the deposition surface (8) while being fitted with an annular first flange surface (24) at the narrower, upper funnel end (28), where the cross-sectional opening of the other, lower funnel end (26) is at least as large the aperture cross-section of the powder bag and where the opening cross-section of the narrower, upper funnel end (28) and its first flange surface (24) are smaller than the aperture cross-section of the powder bag (2), and where the funnel (12) is positioned or positionable at that elevation from the deposition surface (8) on the reversing unit (6) at which the bag end zone (18) projects through the funnel (12) upward as far as above the funnel end (28) and then can be folded outward over the first flange surface (14), in that a head part (32; 32-2) is included which is designed to seal off the narrower, upper funnel end and which is fitted with a second flange surface (34) that can be configured on the first flange surface (24) in order to clamp the folded part (30) of the bag end zone (18) between the two flange surfaces (24, 34), in that it includes a powder feed device (40; 40-2, 40-3, 40-4, 40-5, 40-6; 40, 42, 44) mounted or mountable on the head part (32; 32-2) to feed powder in metered manner from the powder bag, in that it includes moreover a bearing (49) supporting the reversing unit (6) in rotatable manner and, together with the powder bag (2)—which is clamped between the two flange surfaces (24, 34) and trapped between the funnel (12) and the deposition surface (8)—that is rotatable between the upright position wherein the deposition surface (8) points upward and an upside-down position wherein the deposition surface (8) points downward and the powder bag (2) is upside-down in the funnel (12) and the powder feed device (40; 40-2; 40-3,.40-4, 40-5, 40-6; 40, 42, 44) is situated underneath the bag aperture, said aperture being kept open by means of clamping the bag end zone between the two flange surfaces (24, 34).

10. Equipment as claimed in claim 9, characterized in that the retaining fixture (10) includes a lifting element (16) allowing to adjust the height of the funnel (12) at the reversing unit (6) relative to the deposition surface (8).

11. Equipment as claimed in at least one of the above claims 9 and 10, characterized in that the head part (32) comprises a conical funnel extension (52) of the funnel (12), in that the funnel-configuration of the funnel extension (52) tapers continuously from a maximum cross-section to a minimum cross-section and constitutes an extension of the funnel (12) when the head part (32) is clamped onto the funnel (12), the maximum cross-section of the funnel extension (52) being made to match the minimum cross-section of the funnel (12) and being adjacent to said funnel, and where the minimum cross-section of the funnel extension (52) is situated at or near the powder feed device (40; 40, 42; 40-2).

12. Equipment as claimed in at lest one of the above claims 9 through 11, characterized in that it includes a quick-clamping device (36) which engages the outside of the funnel (12) on one hand and the outside of the head part (32; 32, 32-2) on the other hand.

13. Equipment as claimed in claim 12, characterized in that the quick-clamping device (36) comprises a clamping-lever element (54).

14. Equipment as claimed in one of the above claims, characterized in that the powder feed device comprises at least one injector (40-2) in the form of a pneumatic powder pump.

15. Equipment as claimed in one of the above claims, characterized in that the powder feed device comprises several injectors (40-3, 40-4, 40-5, 40-6).

16. Equipment as claimed in at least one of claims 1 through 13, characterized the powder feed device comprises a valve system (40; 40, 42, 44) which can be set to “open” and to “closed” for purposes of controlled powder withdrawal from the powder bag.

17. Equipment as claimed in at least one of the above claims 9 through 16, characterized in that the funnel surface of the funnel (12) is made to converge continuously without steps at least in its region supporting the powder bag (2) from the wide funnel end to the narrow funnel end.

18. Equipment as claimed in at least one of claims 3 through 9, characterized in that the funnel (12) and/or the funnel extension (52) of the head part (32) is continuously converging and free of steps.

19. Equipment as claimed in at least one of the above claims, characterized in that the bag covering assembly (12, 32; 12, 32-2; 212, 232) is fitted with an air connector (72) to apply compensating air into the powder bag (2) in order to at least partly compensate the reduced pressure ensuing from the withdrawal of coating powder from said bag (2).

20. Equipment as claimed in at least one of the above claims, characterized in that the bag covering assembly (12, 32; 12, 32-2; 212, 232) is fitted with at least one powder feed tube (93, 95) running from the head part (32-2) toward the funnel (12) and through the funnel (12) into the powder bag (2), in that the minimum of one powder feed tube (93, 95) comprises, at its end away from the bag covering assembly, a bent-back end zone (94, 96) having an open tube end (98, 100) whereby—in the upright position of the reversing unit (6) and of the powder bag (2)—when the bag covering assembly (12,32; 12, 32-2; 212, 232) is placed on the powder bag (2), the end zone of the minimum of one powder feed tube (93, 95) may be dipped into the coating powder in the powder bag (2) without the powder being forced into the open tube end (98, 100) and whereby, when in the upside-down position of the reversing unit (6) and of the powder bag (2), no powder can drop out of the powder bag (2) into the open tube end (98, 100), and in that a connector (102, 104) to connect at least one powder feed tube (93, 95) with a powder feed line (106,108) is included.

21. Equipment as claimed in claim 20, characterized in that a very soft/flexible hose segment (110, 112) is mounted on the bent-back end segment (94, 96) of the minimum of one powder feed tube (93, 95) and comprises a hose element projecting beyond the open tube end (98, 100) and is so soft and flexible that the projecting tube element can be pinched by external coating powder compressing it and in the process it will be automatically sealed off but on the other hand it may be resiliently forced open again by means of a flow of powder through the powder feed tube (93, 95) into the powder bag (2).

22. Equipment as claimed in either of claims 20 and 21, characterized in that the bag covering assembly (12, 32; 12, 32-2; 212, 232) contains a powder feed device in the form of two or more injectors (40-3, 40-4, 40-5, 40-6) acting as powder-moving pumps.

23. A method to remove in metered manner coating powder from a powder bag,
characterized in that
a cover assembly (12, 32; 12, 32-2; 212, 232) is affixed to the bag aperture of a powder bag (2), and thereupon the powder bag (2) is rotated by a reversing unit (6) bearing the powder bag into an upside-down position and then coating powder is supplied from the upside-down powder bag (2) by means of a powder feed device (40; 40, 42, 44; 40-2; 40-3; 40-4; 40-5; 40-6) configured at the cover assembly.
